(19) United States
(12) Patent Application Publication
(10) Pub. No.: US 2011/0175782 A1
(43) Pub. Date: Jul. 21, 2011

(54) DUAL-BAND DUAL-POLARIZED ANTENNA OF BASE STATION FOR MOBILE COMMUNICATION

(75) Inventors: O-Seok Choi, Gyeonggi-do (KR); Young-Chan Moon, Gyeonggi-do (KR); Hwan-Seok Shim, Gyeonggi-do (KR)

(73) Assignee: KMW INC., Gyeonggi-Do (KR)

(21) Appl. No.: 13/119,854

(22) PCT Filed: Sep. 22, 2009
(86) PCT No.: PCT/KR09/05387

§ 371 Date: Mar. 18, 2011

(30) Foreign Application Priority Data
Sep. 22, 2008 (KR) 10-2008-0092963
Dec. 22, 2008 (KR) 10-2008-0131460
Mar. 13, 2009 (KR) 10-2009-0021874

(51) Int. Cl. H01Q 21/26

(52) U.S. Cl. 343/798

(57) ABSTRACT

Disclosed is a dual-band dual-polarized antenna of a base station for mobile communication, the dual-band dual-polarized antenna including: a reflection plate; one or more first radiating element modules formed on the reflection plate to transmit and receive two linear orthogonal polarized waves for a first frequency band, the one or more first radiating element modules including a plurality of dipoles installed in a general ‘X’ shape; and one or more second radiating element modules for a second frequency band, which are interleaved between the first radiating element modules on the reflection.

### TECHNICAL FIELD

The present invention relates to a dual-band dual-polarized antenna for diversity in a base station for mobile communication (such as PCS, Cellular, or IMT-2000).

### BACKGROUND ART

An antenna of a base station for mobile communication is designed by applying a space diversity scheme or a polarization diversity scheme in order to reduce a fading phenomenon. In the space diversity scheme, a transmission antenna and a reception antenna are spatially spaced more than a certain distance away from each other. Therefore, the space diversity scheme has large spatial constraints and it is not desirable to employ the space diversity scheme in consideration of the cost. Accordingly, a mobile communication system usually uses dual-band dual-polarized antennas while employing the polarization diversity scheme.

The dual-band dual-polarized antennas are arranged perpendicularly to each other. For example, the dual-band dual-polarized antennas are used for transmitting (or receiving) two linear polarized waves, which can be arranged vertically and horizontally, respectively. However, in an actual application, it is very important to operate the antennas in a way capable of arranging the polarized waves in angles of +45 degrees and −45 degrees with respect to the vertical line (or horizontal line). In general, the dual-band dual-polarized antennas are operated using two frequency bands sufficiently spaced apart from each other. An example of the dual-band dual-polarized antenna has been disclosed by Korean Patent Application No. 2000-7010752 (title: dual polarized multi-range antenna), which was filed by KATHREIN-WERKE KG.

FIG. 1 is a perspective view illustrating an example of the conventional dual-band dual-polarized antenna array, and is disclosed in Korean Patent Application No. 2000-7010785. Referring to FIG. 1, the conventional dual-band dual-polarized antenna includes a first radiating element module 1 for a first frequency band (lower frequency band, hereinafter, referred to as a low frequency band) and a second radiating element module 3 for a second frequency band (higher frequency band, hereinafter, referred to as a high frequency band).

The two radiating element modules 1 and 3 are disposed at a front side of an electro-conductive reflection plate 5 actually has a square shape. A feeding network may be disposed at a rear side of the reflection plate 5, and the first and second radiating element modules 1 and 3 are electrically connected to each other through the feeding network. The first radiating element module includes a plurality of dipoles 1a, which are arranged in a generally square shape. The dipoles 1a are mechanically supported on the reflection plate 5 or a plate disposed in the back of the reflection plate 5 by balancing devices 7, and are electrically connected to the reflection plate 5 and the plate disposed in the back of the reflection plate 5. At this time, two edges of the reflection plate 5 includes side walls 6 protruding with a proper height from the two edges of the reflection plate 5, thereby improving a radiation characteristic.

The length of the dipole element of the first radiating element module 1 is set to have a value enabling an electromagnetic wave corresponding to the length of the dipole element to be transmitted or received through the dipole element. Therefore, in the dual-polarized antenna, the dipole elements are arranged perpendicularly to each other. In general, each of the dipole elements 1a are exactly arranged with angles of +45 degrees and −45 degrees with respect to a vertical line (or a horizontal line), so as to form the dual-polarized antenna, which is simply called an X-polarized antenna.

The second radiating element module 3 may be positioned inside or outside the first radiating element module 1 including a plurality of dipoles, which form a square shape. The dipoles of the second radiating element module 3 may form a cross shape, instead of the square shape. Two dipoles 3a disposed perpendicular to each other are also supported on the reflection plate 5 by a corresponding balancing net, and are fed through the balancing net.

The first and second radiating element modules 1 and 3 are disposed at the front side of the reflection plate and are spaced different exact distances apart from each other. In the arrangement of the first and second radiating element modules 1 and 3, the first and second radiating element modules 1 and 3 are interleaved with each other. Further, as shown in FIG. 1, two antenna apparatuses formed by the first and second radiating element modules 1 and 3 may be vertically installed on the reflection plate 5 and an additional second radiating element module 3′ may be installed in a space between the two antenna apparatuses. Through the above arrangement, a high vertical gain is achieved. The above description shows an example of a construction of the conventional dual-band dual-polarized antenna. Further, various researches are in process in order to achieve an optimal structure of the dual-band dual-polarized antenna array, an optimal size of the antenna, a stable characteristic, an easy adjustment to a beam width, and an easy design of the antenna, etc.

### DISCLOSURE

### Technical Problem

Accordingly, the present invention has been made in order to provide a dual-band dual-polarized antenna of a base station for mobile communication, which can achieve an optimal structure arrangement, an optimal antenna size, a stable antenna characteristic, a simpler structure, an easy adjustment to a beam width, and an easy design of the antenna.

### TECHNICAL SOLUTION

In accordance with an aspect of the present invention, there is provided a dual-band dual-polarized antenna of a base station for mobile communication, the dual-band dual-polarized antenna including: a reflection plate; one or more first radiating element modules formed on the reflection plate to transmit and receive two linear orthogonal polarized waves for a first frequency band, the one or more first radiating element modules including a plurality of dipoles installed in a general ‘X’ shape; and one or more second radiating element modules for a second frequency band, which are interleaved between the first radiating element modules on the reflection.

In accordance with another aspect of the present invention, there is provided a dual-band dual-polarized antenna of a base station for mobile communication, the dual-band dual-polarized antenna including: a reflection plate; one or more first radiating element modules formed on the reflection plate to transmit and receive two linear orthogonal polarized waves for a first frequency band, the one or more first radiating element modules including a plurality of dipoles installed in a general ‘>>’ shape or a general “<<” shape; and one or more second radiating element modules for a second frequency band, which are interleaved between the first radiating element modules on the reflection.

### ADVANTAGEOUS EFFECTS

According to the dual-band dual-polarized antenna of the present invention, it is possible to achieve a more optimal structure arrangement, an optimal antenna size, a stable characteristic, a simpler structure, an easy adjustment to a beam width, and an easy design of the antenna.

### BRIEF DESCRIPTION OF THE DRAWINGS

FIG. 1 is a perspective view illustrating an example of the conventional dual-band dual-polarized antenna array;

FIG. 2 is a perspective view illustrating a dual-band dual-polarized antenna array according to a first embodiment of the present invention;

FIG. 3 is a view illustrating a structure of a dipole included in a first radiating element module of FIG. 2;

FIG. 4 is a plan view of the antenna array shown in FIG. 2;

FIG. 5 is a perspective view of a dual-band dual-polarized antenna array according to a second embodiment of the present invention;

FIG. 6 is a view illustrating a structure of a dipole included in a first radiating element module of FIG. 5;

FIG. 7 is a plan view of the antenna array shown in FIG. 5;

FIG. 8 is a plan view of a dual-band dual-polarized antenna array according to a third embodiment of the present invention;

FIG. 9 is a plan view of a dual-band dual-polarized antenna array according to a fourth embodiment of the present invention;

FIG. 10 is a plan view of a dual-band dual-polarized antenna array according to a fifth embodiment of the present invention;

FIG. 11 is a plan view of a dual-band dual-polarized antenna array according to a sixth embodiment of the present invention;

FIG. 12 is a plan view of a dual-band dual-polarized antenna array according to a seventh embodiment of the present invention;

FIG. 13 is a plan view of a dual-band dual-polarized antenna array according to an eighth embodiment of the present invention;

FIG. 14 is a graph illustrating a beam characteristic according to the first embodiment of the present invention;

FIG. 15 is a graph illustrating a beam characteristic according to the fifth embodiment of the present invention; and

FIG. 16 is a graph illustrating a beam characteristic according to the seventh embodiment of the present invention.

### BEST MODE

### Mode for Invention

Hereinafter, the exemplary embodiments of the present invention will be described with reference to the accompanying drawings.

In the following description, specific matters such as a specific construction device, etc. are discussed, but it will be understood by those skilled in the art that various changes in form and details may be made therein without departing from the spirit and scope of the inventions as defined by the appended claims.

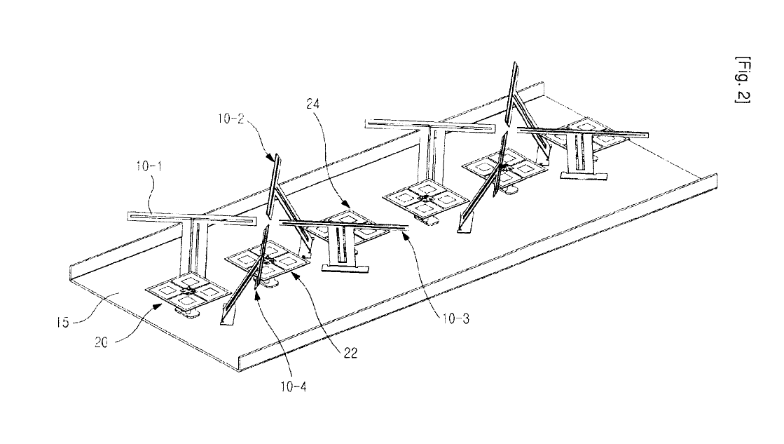

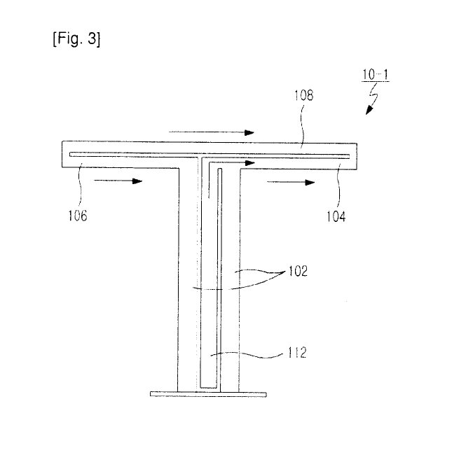

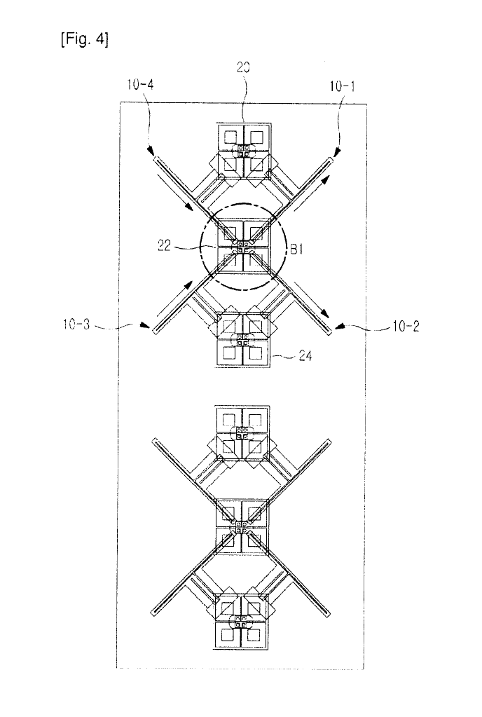

FIG. 2 is a perspective view illustrating a dual-band dual-polarized antenna array according to a first embodiment of the present invention, FIG. 3 is a view illustrating a structure of a dipole included in a first radiating element module of FIG. 2, and FIG. 4 is a plan view of FIG. 2. Referring to FIGS. 2 to 4, the dual-band dual-polarized antenna array includes a plurality of first radiating element modules 10 (10 collectively refers to reference numbers including 10-1, 10-2, 10-3, and 10-4) having a low frequency band (e.g. 800 MHz band), which are installed at a front side of the reflection plate 15, and a plurality of second radiating element modules 20, 22, and 24 having a high frequency band (e.g. 2 GHz band), which are properly interposed between the first radiating element modules 10.

One first radiating element module among the plural first radiating element modules may include first to fourth dipoles 10-1 to 10-4.

In order to implement an X polarized wave, the first radiating element modules 10 has a general X-shaped structure, instead of the conventional square-shaped structure. That is, the first to fourth dipoles 10-1 to 10-4 form ends of the X-shaped structure, respectively. At this time, as shown in FIG. 4, the first and third dipoles 10-1 and 10-3 form the polarized wave having an angle of +45 degrees, and the second and fourth dipoles 10-2 and 10-4 form the polarized wave having an angle of −45 degrees.

FIG. 3 illustrates a detailed structure of the first dipole 10-1. Referring to FIG. 3, the first to fourth dipoles 10-1 to 10-4 according to the present invention have folded dipole structures.

The folded dipole includes first side and second side dipole elements 104 and 106, which are divided into a left side element and a right side element and has a total length changeable according to a corresponding frequency, an electro-conductive balun 102, which has a proper shape so as to individually support each of the first and second dipole elements 104 and 106, a feeding line 112, which extends toward a length direction of the balun 102 and is connected to an internal end of the first dipole element 104, and a third dipole element 108, which extends in a lengthwise direction of the first and second dipole elements 104 and 106, interconnects external ends of the first and second dipole elements 104 and 106, and is parallel to the dipole elements 104 and 106. At this time, the fist and second dipole elements 104 and 106, the balun 102, the feeding line 112, and the third dipole element 108 can be integrally connected with each other through a metal pattern on a flat metal surface.

In the folded dipole, when a current is provided through the feeding line 112, an antenna mode electric field is generated in the first and second dipole elements 104 and 106, along a direction as indicated by arrows shown in FIG. 3 and an electric field is induced in the third dipole element 105, along the direction (refer to the arrows in FIG. 3) same as that in the first and second dipole elements 104 and 106. The folded dipole is more stable in a broad band characteristic and in a change of a horizontal beam width of an antenna, and has a simpler feeding structure in comparison with a general dipole.

In the first to fourth dipoles 10-1, 10-2, 10-3, and 10-4 of the first radiating element module 10 using the folded dipole according to the present invention, the first and third dipoles 10-1 and 10-3 are installed in such a manner that they have a slope of +45 degrees and induce an electric field of +45 degrees arranging and directly forming a polarized wave of +45 degrees among all polarized waves. Similarly, the second and fourth dipoles 10-2 and 10-4 are installed in such a manner that they have a slope of −45 degrees and induce an electric field of −45 degrees arranging and directly forming a polarized wave of −45 degrees among all polarized waves.

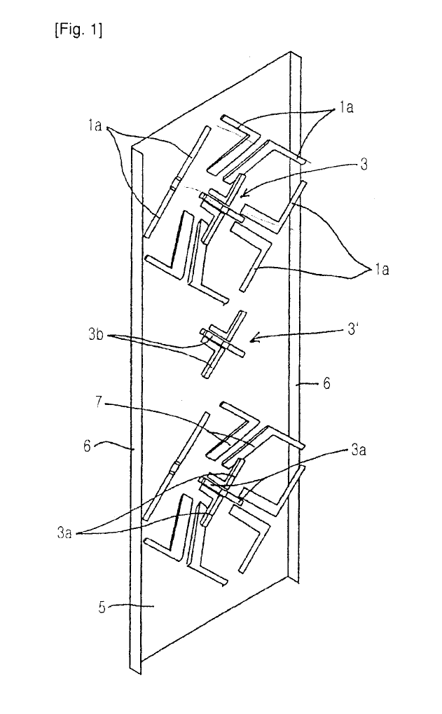

Meanwhile, FIGS. 2 and 4 illustrate a Printed Circuit Board (PCB)-type radiating element as an example of the second radiating element modules 20, 22, and 24. Typical radiating element modules for a high frequency band including the conventional second radiating element module 3 shown in FIG. 1 can be employed as the second radiating element modules 20, 22, and 24.

Further, in FIGS. 2 and 4, for example, the first radiating element modules 10 are installed at two portions and the second radiating element modules are installed at a center, an upper part, and a lower part of the installation ranges of the first radiating element modules 10 generally having the ‘X’ shape, respectively. As a result, the first radiating element modules 10 installed at two portions are interleaved with a predetermined number of second radiating element modules. However, the above-described arrangement is only an example for convenience of description, and it goes without saying that the total number of the first or second radiating element modules and intervals between the modules can be changed according to the design of the specific antenna array. Basically, the second radiating element module(s) can be disposed in parallel with a central axis of the installation in a vertical or a horizontal direction in which the first radiating element module is disposed.

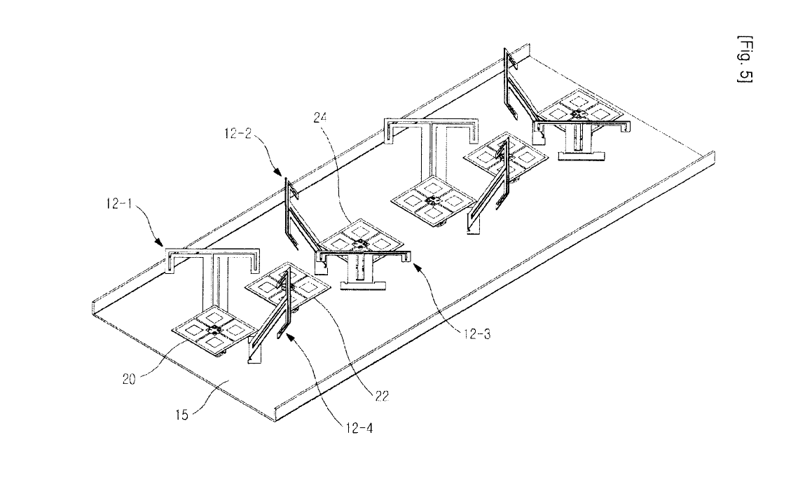

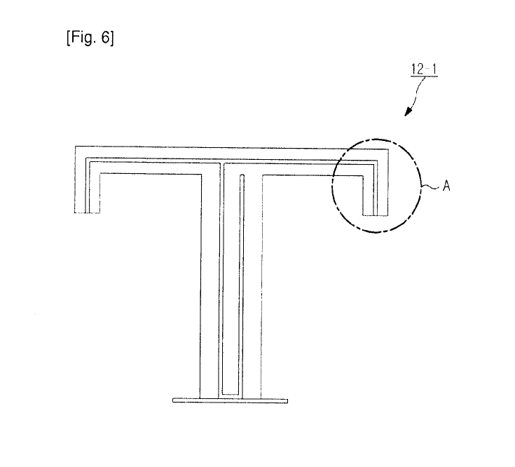

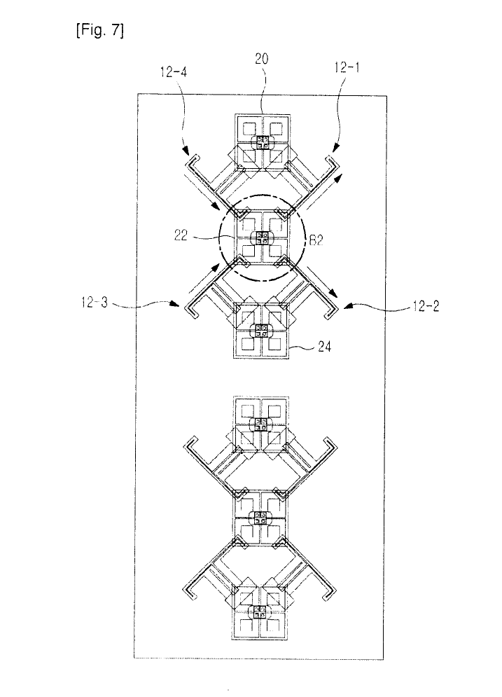

FIG. 5 is a perspective view of a dual-band dual-polarized antenna array according to a second embodiment of the present invention, FIG. 6 is a view illustrating a structure of a dipole included in the first radiating element module of FIG. 5, and FIG. 7 is a plan view of the antenna array shown in FIG. 5. Referring to FIGS. 5 to 7, the dual-band dual-polarized antenna array according to the second embodiment of the present invention includes a plurality of first radiating element modules 12 (12 collectively refers to reference numbers including 12-1, 12-2, 12-3, and 12-4), which are installed at a front side of the reflection plate 15 and a plurality of second radiating element modules 20, 22, and 24, which are installed in such a manner that the second radiating element modules 20, 22, and 24 are properly interposed between the first radiating element modules 12, like the structure of the first embodiment shown in FIGS. 2 to 4.

At this time, a detailed structure of the first radiating element module 12 according to the second embodiment of the present invention is different from the structure of the first embodiment. That is, as shown in FIG. 6 in detail, the first to fourth dipoles 12-1, 12-2, 12-3, and 12-4 included in the first radiating element module 12 have the folded dipole shape identical to that of the first embodiment. However, as shown in FIG. 4, the first to fourth dipoles 12-1, 12-2, 12-3, and 12-4 have at least one bent part (A in FIG. 6) among external ends of the dipole element. The second embodiment of FIGS. 5 to 7 illustrates a structure in which all the external ends of the dipole element are bent as an example. At this time, the bent parts do not exceed a half of total length of the dipole element.

In a general dipole structure, strong electric fields generated in the external ends of the dipole element may have an influence on adjacent dipole elements. However, the folded dipole having a bent structure as described above can reduce the strong electric field applied to the adjacent dipole elements.

Further, as in the encircled part B1 of FIG. 4 according to the first embodiment of the present invention, when the first radiating element module is arranged in the ‘X’ shape, dipoles of the radiating element modules become closer to each other so as to generate a strong coupling, which causes different polarized waves to have an influence on each other. At this time, as in the encircled part B2 of FIG. 7 according to the second embodiment of the present invention, the polarized waves are spaced apart from each other by the folded dipole having the bent structure, so as to reduce the influence of the polarized waves.

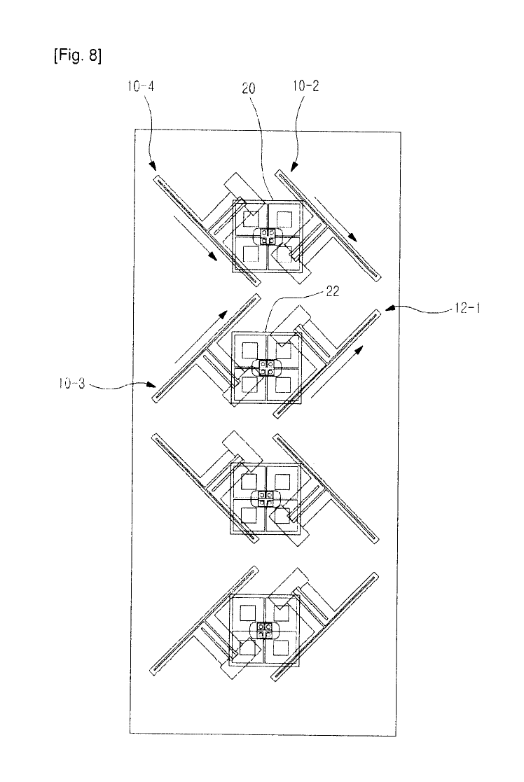

FIG. 8 is a plan view of a dual-band dual-polarized antenna array according to a third embodiment of the present invention. Referring to FIG. 8, the dual-band dual-polarized antenna array according to the third embodiment of the present invention includes the first radiating element module 10 (10 collectively refers to reference numbers including 10-1, 10-2, 10-3, and 10-4) including the first to fourth dipoles 10-1 to 10-4 having the folded dipole structure identical to that of the first embodiment shown in FIGS. 2 to 4. At this time, the first radiating element module 10 has a “>>” shaped structure or “<<” shaped structure, instead of a general X-shaped structure. That is, in the third embodiment, locations of the first dipole 10-1 and the second dipole 10-2, which were described in the first embodiment having the X-shaped structure of the first radiating element module, are exchanged.

According to the above construction, the first and third dipoles 10-1 and 10-3 among the first to fourth dipoles 10-1, 10-2, 10-3, and 10-4 of the first radiating element module 10 are installed in parallel to each other and have a slope of +45 degrees. The first and third dipoles 10-1 and 10-3 directly form a polarized wave of +45 degrees among all the polarized waves of the antenna according to each of conditions in which the first and third dipoles 10-1 and 10-3 are installed. Similarly, the second and fourth dipoles 10-2 and 10-4 are installed in parallel to each other and have a slope of −45 degrees. The second and fourth dipoles 10-2 and 10-4 directly form a polarized wave of −45 degrees among all the polarized waves of the antenna according to each of conditions in which the second and fourth dipoles 10-2 and 10-4 are installed.

Meanwhile, FIG. 8 illustrates four second radiating element modules 20 and 22 installed at four portions, dislike the first embodiment including six second radiating element modules installed at six portions for two first radiating element modules installed in two portions, three second radiating element modules among the six second radiating element modules corresponding to one first radiating element module among the two first radiating element modules. Therefore, it is possible to achieve an easy design of the antenna such as controlling the optimal number of the second radiating element modules and intervals between each of the modules, by combining the structures of the embodiments of the present invention.

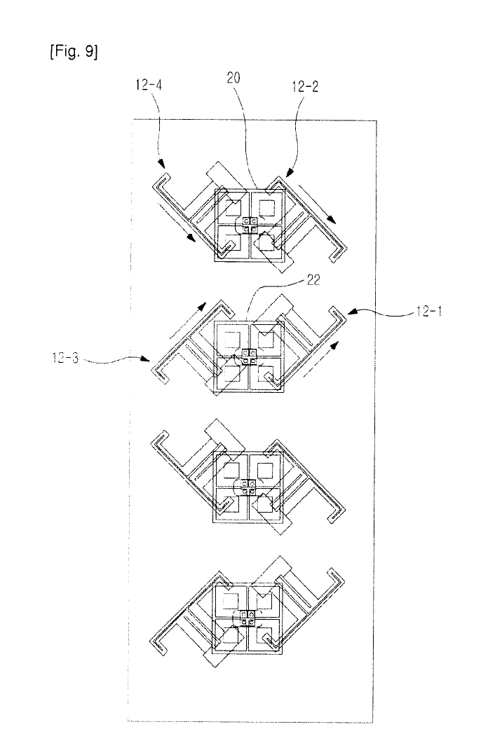

FIG. 9 is a plan view of a dual-band dual-polarized antenna array according to a fourth embodiment of the present invention. Referring to FIG. 9, the dual-band dual-polarized antenna array according to the fourth embodiment is almost the same as the construction of the dual-band dual-polarized antenna array of the third embodiment shown in FIG. 8. However, at this time, the first to fourth dipoles (12-1, 12-2, 12-3, and 12-4) included in the first radiating element module 12 (12 collectively refers to reference numbers including 12-1, 12-2, 12-3, and 12-4) according to the fourth embodiment of the present invention employs the folded dipole structure having the bent parts of the second embodiment shown in FIGS. 5 to 7.

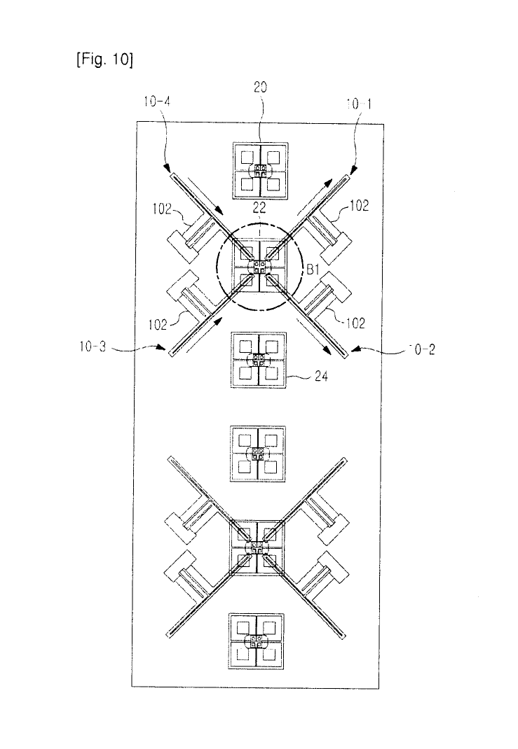

FIG. 10 is a plan view of a dual-band dual-polarized antenna array according to a fifth embodiment of the present invention. Referring to FIG. 10, a structure of the dual-band dual-polarized antenna array according to the fifth embodiment of the present invention is almost the same as the structure of the dual-band dual-polarized antenna array according to the first embodiment of the present invention shown in FIGS. 2 to 4. However, the first to fourth dipoles 10-1, 10-2, 10-3, and 10-4 for implementing the X polarized wave in the 800 MHz first radiating element module 10 have a structure in which the installation ranges of the electro-conductive baluns 102 should not overlap with the installation ranges, which are defined on a central axis, of the 2 GHz second radiating element modules 20, 22, and 24 and the electro-conductive baluns 120 should be positioned as far away as possible from the second radiating element modules 20, 22, 24 so that the baluns 120 are installed at right and left parts of all the first radiating element modules 10. That is, as shown in FIG. 10, each of the baluns 102 are installed in an inclined shape in such a manner that the baluns 102 have lower ends, which are farther apart than upper ends from the second radiating element modules 20.

When the baluns 120 of the first radiating element module 10 are disposed close to the second radiating element modules 20, 22, and 24, a Cross-Polarization Ratio (CPR) characteristic may be deteriorated. Therefore, the aforementioned installation of the baluns enables the CPR characteristic to be improved.

Accordingly, the structure, in which the baluns 102 are slantingly installed in such a manner that the baluns 102 have the lower ends placed farther apart than the upper ends from the second radiating element modules 20, 22, and 24, has a property capable of improving the CPR characteristic. At this time, the above structure of the baluns 102 can be employed to the first radiating element module having a typical diamond structure shown in FIG. 1 as well as the first radiating element module having the general X-shaped structure described above. When the above structure of the baluns 102 are employed to the first radiating element module having the diamond shape, from a front view, the baluns are positioned outside the general diamond structure of the first radiating element module, instead of ranges corresponding to an inside of the diamond structure of the first radiating element module described in the conventional structure of the baluns.

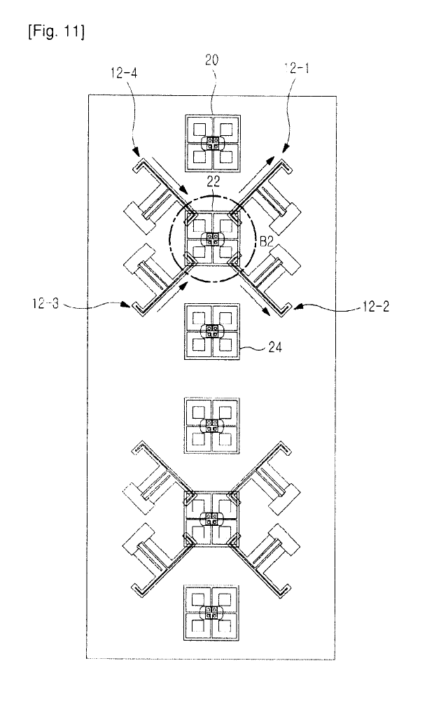

FIG. 11 is a plan view of a dual-band dual-polarized antenna array according to a sixth embodiment of the present invention. Referring to FIG. 11, a dual-band dual-polarized antenna array structure according to the sixth embodiment of the present invention is almost the same as the dual-band dual-polarized antenna array structure according to the second embodiment of the present invention shown in FIGS. 5 to 7. However, like the modified example shown in FIG. 10, the first to fourth dipoles 12-1, 12-2, 12-3, and 12-4 of the 800 MHz first radiating element module 12 have a structure in which the installation ranges of the electro-conductive baluns do not overlap with the installation ranges of the second radiating element modules 20, 22, and 24 and the electro-conductive baluns are positioned as far away as possible from the second radiating element modules 20, 22, and 24. As a result, the electro-conductive baluns are positioned at left and right parts of all the first radiating element modules 12.

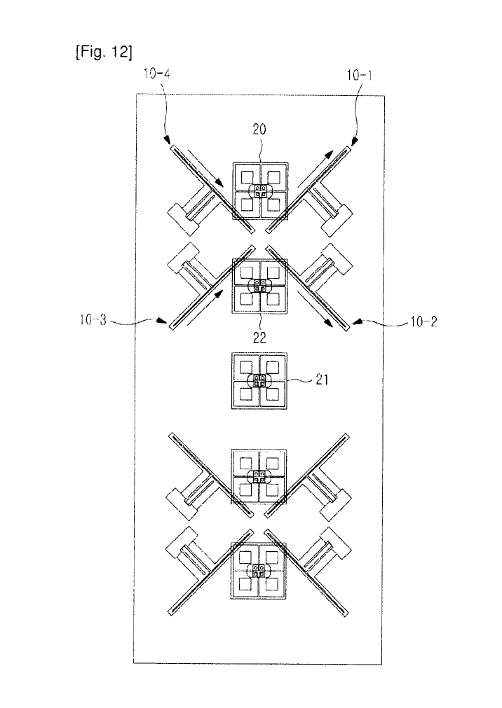

FIG. 12 is a plan view of a dual-band dual-polarized antenna array according to a seventh embodiment of the present invention. Referring to FIG. 12, the dual-band dual-polarized antenna array according to the seventh embodiment of the present invention is almost the same as the dual-band dual-polarized antenna array according to the fifth embodiment of the present invention shown in FIG. 10. However, the antenna array according to the seventh embodiment of the present invention has a different mutual arrangement structure between the first radiating element module 10 and the second radiating element modules 20, and 22 from that of the fifth embodiment.

That is, in the structure shown in FIG. 10, for example, the first radiating element modules 10 are installed at two portions and the second radiating element modules 20, 22, and 24 are installed at a center, and upper and lower parts of the center of the installation ranges of the first radiating element modules 10 having the general ‘X’ shape, respectively. However, as shown in FIG. 12, the antenna array according to the seventh embodiment has a structure in which the second radiating element modules 20 and 22 are not installed at the center of the ‘X’ shape of the first radiating element modules 10. The second radiating element modules 20 (20-1 and 20-2 in FIG. 12) stray from the center of the ‘X’ shape, which are included in the installation ranges of the first radiating element modules 10 and are installed at the upper and lower parts of the ‘X’ shape, respectively.

Further, an additional second radiating element module 21 can be installed in a space between the first radiating element modules 10 installed at two portions, in order to maintain a regular arrangement interval between the second radiating element modules.

The mutual arrangement structure between the first radiating element modules 10 and the second radiating element modules 20, 22, and 21 shown in FIG. 12 can reduce factors having a bad influence on the CPR characteristic in comparison with the structure in which the second radiating element modules are installed at the center of the ‘X’ shape of the first radiating element modules 10, thereby improving the CPR characteristic.

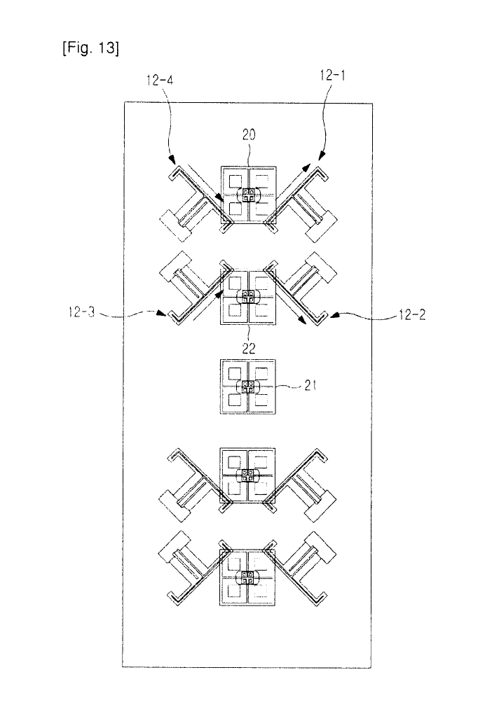

FIG. 13 is a plan view of a dual-band dual-polarized antenna array according to an eighth embodiment of the present invention. Referring to FIG. 13, the dual-band dual-polarized antenna array according to the eighth embodiment of the present invention is almost the same as the dual-band dual-polarized antenna array according to the fifth embodiment of the present invention shown in FIG. 10. However, like the seventh embodiment shown in FIG. 12, the second radiating element modules 20 and 22 are not installed at the center of the ‘X’ shape of the first radiating element modules 10. The second radiating element modules 20 (20-1 and 20-2 in FIG. 12) stray from the center of the ‘X’ shape, which is included in the installation ranges of the first radiating element modules 10 and are installed at the upper and lower parts of the ‘X’ shape, respectively.

Further, in the eighth embodiment shown in FIG. 13, the additional second radiating element module 21 can be installed in a space between the first radiating element modules 10 installed at two portions, in order to maintain the regular arrangement interval between the second radiating element modules like the seventh embodiment shown in FIG. 12.

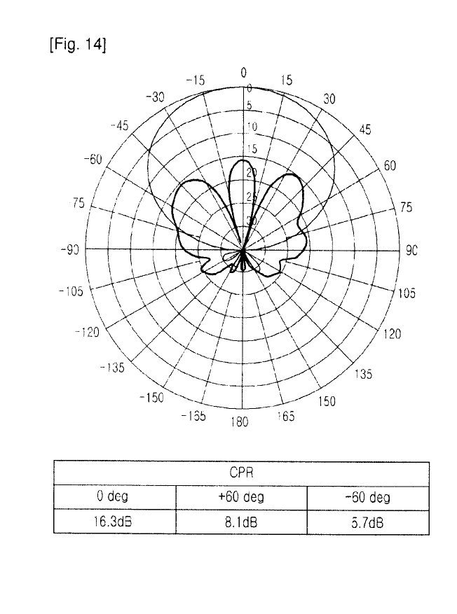

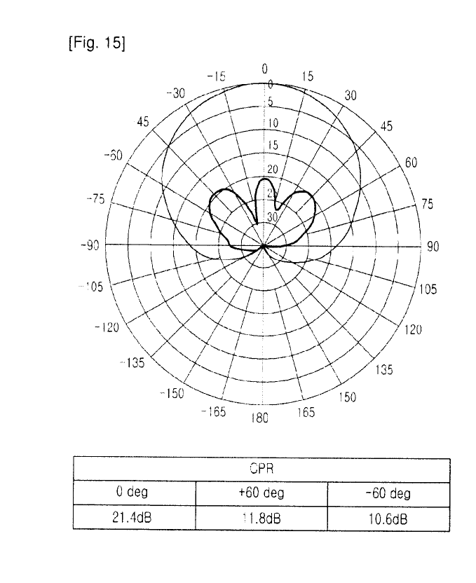

FIG. 14 is a graph illustrating a beam characteristic according to the first embodiment of the present invention, and FIG. 15 is a graph illustrating a beam characteristic according to the fifth embodiment of the present invention. Referring to FIGS. 14 and 15, in the fifth embodiment, improved overall CPR characteristics, which include 21.4 dB changed from 16.3 dB in an angle of 0 degrees, 11.8 dB changed from 8.1 dB in an angle of +60 degrees, and 10.6 dB changed from 5.7 dB in an angle of −60 degrees, are measured in comparison with the CPR characteristic of the first embodiment.

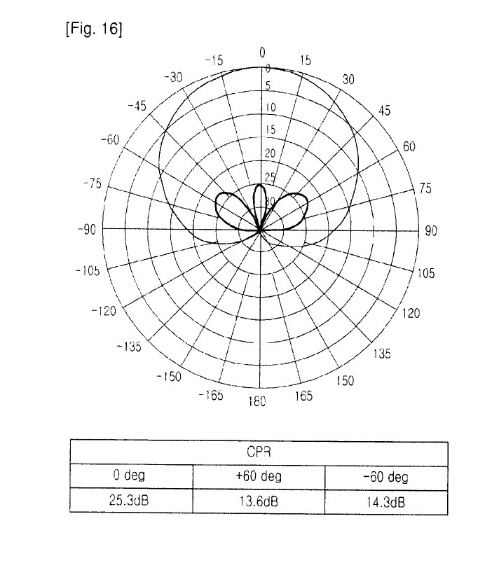

Further, FIG. 16 is a graph illustrating a beam characteristic according to the seventh embodiment of the present invention. Referring to FIG. 16, in the seventh embodiment, the more improved overall CPR characteristics, which include 25.3 dB changed from 21.4 dB in an angle of 0 degrees, 13.6 dB changed from 11.8 dB in an angle of +60 degrees, and 14.3 dB changed from 10.6 dB in an angle of −60 degrees, are measured in comparison with the CPR characteristic in the fifth embodiment.

As described above, it is possible to implement the dual-band dual-polarized antenna according to an embodiment of the present invention. While the present invention has been described with reference to certain preferred embodiments thereof, it will be understood by those skilled in the art that various changes in form may be made therein without departing from the scope of the present invention. For example, in the above description, modified examples of the first and second embodiments are illustrated in FIGS. 10 and 11, respectively, and similar modifications may be applied to the third and fourth embodiments illustrated in FIGS. and 9, respectively. That is, the first radiating element modules illustrated in FIGS. 8 and 9 have a structure in which the baluns may be installed at the left and right parts of all the first radiating element modules in order to install the baluns as far away as possible from the second radiating element modules. Therefore, the present invention may include various changes and modifications and thus the scope of the invention is not defined by the described embodiments but should be defined by the claim and the equivalence of the claim.

### INDUSTRIAL APPLICABILITY

Although several exemplary embodiments of the present invention have been described for illustrative purposes, those skilled in the art will appreciate that various modifications, additions and substitutions are possible, without departing from the scope and spirit of the invention as disclosed in the accompanying claims.

1. A dual-band dual-polarized antenna of a base station for mobile communication, the dual-band dual-polarized antenna comprising:
a reflection plate;
one or more first radiating element modules formed on the reflection plate to transmit and receive two linear orthogonal polarized waves for a first frequency band, the one or more first radiating element modules comprising a plurality of dipoles installed in a general ‘X’ shape; and
one or more second radiating element modules for a second frequency band, which are installed on the reflection plate together with the one or more first radiating element modules.

2. The dual-band dual-polarized antenna as claimed in claim 1, wherein each of the baluns has lower end, which is spaced farther apart from the second radiating element module than upper end thereof, so that electro-conductive baluns of first to fourth dipoles of the first radiating element module have installation ranges spaced as far as possible away from installation ranges of the second radiating element modules.

3. The dual-band dual-polarized antenna as claimed in claim 1, wherein the first radiating element module comprises the first, second, third, and fourth dipoles forming ends of the ‘X’ shape,
the first and third dipoles are disposed at an inclination of +45 degrees, respectively, and induce an electric field of +45 degrees directly forming a polarized wave of ₊45 degrees among all polarized waves of the antenna according to installation states of the first and third dipoles, and
the second and fourth dipoles are disposed at an inclination of −45 degrees, respectively, and induce an electric field of −45 degrees directly forming a polarized wave of −45 degrees among all polarized waves of the antenna according to installation states of the second and fourth dipoles.

4. The dual-band dual-polarized antenna as claimed in claim 3, wherein the first to fourth dipoles of the first radiating element module has a folded dipole type.

5. The dual-band dual-polarized antenna as claimed in claim 3, wherein at least a part of the first to fourth dipoles of the first radiating element module comprises a folded dipole, and at least one external end among external ends of the folded dipole has a bent portion.

6. The dual-band dual-polarized antenna as claimed in claim 3, wherein the second radiating element module strays from a center of the ‘X’ shape of the first radiating element module and is installed at an upper part and a lower part of the ‘X’ shape of the first radiating element module.

7. A dual-band dual-polarized antenna of a base station for mobile communication, the dual-band dual-polarized antenna comprising:
a reflection plate;
one or more first radiating element modules formed on the reflection plate to transmit and receive two linear orthogonal polarized waves for a first frequency band, the one or more first radiating element modules comprising a plurality of dipoles installed in a general ‘X’ shape; and
one or more second radiating element modules for a second frequency band, which are installed on the reflection plate together with the one or more first radiating element modules,
wherein the second radiating element module strays from a center of the ‘X’ shape of the first radiating element module and is installed at an upper part and a lower part of the ‘X’ shape of the first radiating element module.

8. The dual-band dual-polarized antenna as claimed in claim 7, wherein the first radiating element module comprises first, second, third, and fourth dipoles forming ends of the ‘X’ shape,
the first and third dipoles are disposed at an inclination of +45 degrees, respectively, and induce an electric field of +45 degrees directly forming a polarized wave of +45 degrees among all polarized waves of the antenna according to installation states of the first and third dipoles, and
the second and fourth dipoles are disposed at an inclination of −45 degrees, respectively, and induce an electric field of −45 degrees directly forming a polarized wave of −45 degrees among all polarized waves of the antenna according to installation states of the second and fourth dipoles.

9. The dual-band dual-polarized antenna as claimed in claim 8, wherein the first to fourth dipoles of the first radiating element module has a folded dipole type.

10. The dual-band dual-polarized antenna as claimed in claim 8, wherein at least a part of the first to fourth dipoles of the first radiating element module comprises a folded dipole, and at least one external end among external ends of the folded dipole has a bent portion.

11. A dual-band dual-polarized antenna of a base station for mobile communication, the dual-band dual-polarized antenna comprising:
a reflection plate;
one or more first radiating element modules formed on the reflection plate to transmit and receive two linear orthogonal polarized waves for a first frequency band, the one or more first radiating element modules comprising a plurality of dipoles installed in a general ‘>>’ shape or a general “<<” shape; and
one or more second radiating element modules for a second frequency band, which are installed on the reflection plate together with the one or more first radiating element modules.

12. The dual-band dual-polarized antenna as claimed in claim 11, wherein each of the baluns has lower end, which is spaced farther apart from the second radiating element module than upper end thereof, so that electro-conductive baluns of first to fourth dipoles of the first radiating element module have installation ranges spaced as far as possible away from installation ranges of the second radiating element modules.

13. The dual-band dual-polarized antenna as claimed in claim 12, wherein the first radiating element module comprises first, second, third, and fourth dipoles forming ends of the “>>” shape or the “<<” shape, the first and third dipoles are disposed at an inclination of +45 degrees, respectively, and induce an electric field of +45 degrees directly forming a polarized wave of +45 degrees among all polarized waves of the antenna according to installation states of the first and third dipoles, and
the second and fourth dipoles are disposed at an inclination of −45 degrees, respectively, and induce an electric field of −45 degrees directly forming a polarized wave of −45 degrees among all polarized waves of the antenna according to installation states of the second and fourth dipoles.

14. The dual-band dual-polarized antenna as claimed in claim 13, wherein the first to fourth dipoles of the first radiating element module has a folded dipole type.

15. The dual-band dual-polarized antenna as claimed in claim 13, wherein at least a part of the first to fourth dipoles of the first radiating element module comprises a folded dipole, and at least one external end among external ends of the folded dipole has a bent portion.

16. A dual-band dual-polarized antenna of a base station for mobile communication, the dual-band dual-polarized antenna comprising:
a reflection plate;
one or more first radiating element modules formed on the reflection plate to transmit and receive two linear orthogonal polarized waves for a first frequency band, the one or more first radiating element modules comprising a plurality of dipoles; and
one or more second radiating element modules for a second frequency band, which are installed on the reflection plate together with the one or more first radiating element modules,
wherein each of the baluns has lower end, which is spaced farther apart from the second radiating element module than upper end thereof, so that electro-conductive baluns of first to fourth dipoles of the first radiating element module have installation ranges spaced as far as possible away from installation ranges of the second radiating element modules.

17. The dual-band dual-polarized antenna as claimed in claim 16, wherein the first radiating element module has a plurality of dipoles installed in a general ‘X’ shape or a general diamond shape.

18. The dual-band dual-polarized antenna as claimed in claim 2, wherein the first radiating element module comprises the first, second, third, and fourth dipoles forming ends of the ‘X’ shape,
the first and third dipoles are disposed at an inclination of +45 degrees, respectively, and induce an electric field of +45 degrees directly forming a polarized wave of ₊45 degrees among all polarized waves of the antenna according to installation states of the first and third dipoles, and
the second and fourth dipoles are disposed at an inclination of −45 degrees, respectively, and induce an electric field of −45 degrees directly forming a polarized wave of −45 degrees among all polarized waves of the antenna according to installation states of the second and fourth dipoles.

19. The dual-band dual-polarized antenna as claimed in claim 12, wherein the first radiating element module comprises first, second, third, and fourth dipoles forming ends of the “>>” shape or the “<<” shape,
the first and third dipoles are disposed at an inclination of +45 degrees, respectively, and induce an electric field of +45 degrees directly forming a polarized wave of +45 degrees among all polarized waves of the antenna according to installation states of the first and third dipoles, and
the second and fourth dipoles are disposed at an inclination of −45 degrees, respectively, and induce an electric field of −45 degrees directly forming a polarized wave of −45 degrees among all polarized waves of the antenna according to installation states of the second and fourth dipoles.
